(19) United States
(12) Patent Application Publication
(10) Pub. No.: US 2004/0255700 A1
(43) Pub. Date: Dec. 23, 2004

(54) Device for determining a force

(76) Inventors: Andreas Aumer, Regensburg (DE); Ulrich Deml, Lappersdorf (DE); Manfred Frimberger, Ergoldsbach (DE)

Correspondence Address: MORRISON & FOERSTER LLP, 1650 TYSONS BOULEVARD, SUITE 300, MCLEAN, VA, 22102, US

(21) Appl. No.: 10/472,596

(22) PCT Filed: Mar. 22, 2002
(86) PCT No.: PCT/DE02/01057

(30) Foreign Application Priority Data
Mar. 23, 2001 (DE) 101 14 312.5

(51) Int. Cl. G01L 1/26

(52) U.S. Cl. 73/862.391

(57) ABSTRACT

A device for determining the weight of vehicle occupants or objects on vehicle seats is proposed, which has two elements interconnected via a spring arrangement. A position sensor is also provided to determine the position of the first element in relation to the second element. The first element can tilt about a fulcrum. The position sensor is arranged in relation to the longitudinal extension of the second element in a position which is predefined by a perpendicular projection of the fulcrum onto this second element.

### CLAIM FOR PRIORITY

This application claims priority to International Application No. PCT/DE02/01057 as published in the German language on Oct. 3, 2002, which claims the benefit of priority to German Application No. 10114312.5 which was filed in the German language on Mar. 23, 2001.

### TECHNICAL FIELD OF THE INVENTION

The invention relates to a device for determining the weight of vehicle occupants or objects on vehicle seats.

### BACKGROUND OF THE INVENTION

It is frequently necessary to define translatory, in other words rectilinear, distances, determine positions or derive forces underlying distances or distance changes from the positions determined.

In doing so, the problem is frequently encountered that an element moving essentially in a translatory manner is exposed to forces with a rotary action, which turn or tip the element. During the action of such a torque, however, a translatory deflection is also detected by a measuring sensor due to the rotation of the element. A rectilinear deflection is always detected both in the case of a force acting in a rectilinear manner and in the case of a torque action. It cannot be distinguished whether this deflection has been produced by a force with a rotary action or a rectilinear action. With many applications it is however extremely important only to be able to define forces with a rectilinear action.

A possible solution is the provision of guides for the movable element. These guides then only permit a translatory deflection of the element when a force with rectilinear action acts on the element, as the guides mean that torque cannot result in any deflection. However guides always cause frictional forces between the guide and the moving element and these can corrupt the measurement result significantly.

### SUMMARY OF THE INVENTION

The invention is directed to a device for the precise measurement of translatory forces.

According to an apect of the invention, a device is provided for determining a weight of vehicle occupants or objects on vehicle seats. The device includes first and second elements, where a distance between the first and second elements depends on a force acting thereon. The second element has a longitudinal extension. A spring arrangement is provided which connects the first and second elements. The spring arrangement contains a leaf spring which is oriented parallel to the second element, and secured at its ends at spigots connected to the second element and coupled to the first element in such a way that a force from the first element is transferred to a position of the leaf spring that is central in relation to its longitudinal extension. A position sensor for determining a position of the first element in relation to the second element is provided. The first element can be tilted about a fulcrum in relation to the second element, and the position sensor is arranged centrally between spigots.

According to another aspect of the invention, a special arrangement of a position sensor, which is configured to detect a position, a distance or a distance change is provided. This sensor is positioned in relation to the longitudinal extension of a second element, toward or away from which the first element is generally moved in a translatory manner due to the action of a force, said position being predefined by a perpendicular projection of a possible fulcrum onto this second element. The fulcrum is defined by the geometry of the entire device when a torque is acting on the freely movable element.

A device was found which is able to detect a path in a predefined direction of measurement. Measurement results produced by tipping are avoided to the greatest possible degree in this way, as the sensor is arranged in that position, which is exposed in respect of the direction of measurement to the smallest deflections of the freely movable element during tilting or rotation. Complex structural configuration of a guide for the movable element is no longer necessary. The sensor principle is non-contact and it only detects the deflection of the movable element in the direction of measurement. As well as being less complex, such a device is also more economical.

### BRIEF DESCRIPTION OF THE DRAWINGS

FIG. 1 a device according to the invention for determining a force using a position sensor;

FIG. 2 the cross-section of the position sensor from FIG. 1 along the section line R-R′;

FIG. 3 a diagrammatic representation of the problem of path measurement scanning underlying the invention;

FIG. 4 the device from FIG. 1 subject to a torque action;

FIG. 5 a further device according to the invention in cross-section;

FIG. 6 the device from FIG. 5 subject to a torque action.

### DETAILED DESCRIPTION OF THE INVENTION

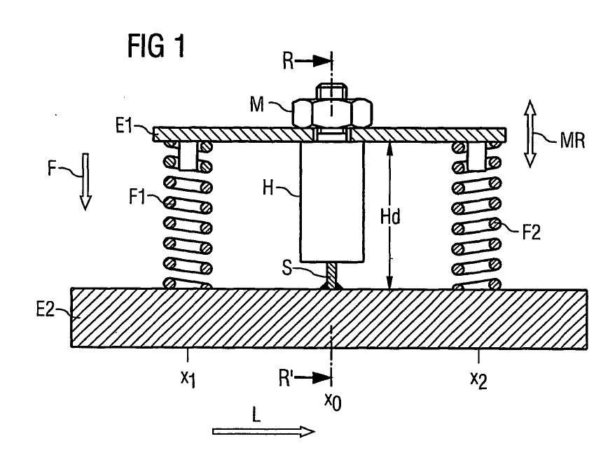

FIG. 1 shows a device according to the invention with a position sensor S, H, which is arranged between a first element E1 and a second element E2. The structure of the position sensor is described using specific figures. The distance Hd between the element E1 and the element E2 is to be measured. The element E1 and the element E2 are connected to each other by a spring arrangement with springs F1 and F2 at a distance from each other and shown with symbols. A force F acts on the element E1 in the direction of the arrow. The force F may be a weight force, a pressure force or a tensile force. The element E2 is supported so that it cannot be moved in the direction of the force, so that the action of the force F causes the element E1 to be moved in a rectilinear manner toward the element E2. The position of the element E1 in relation to the element E2 or the distance between the elements E1 and E2 is detected. With knowledge of the spring characteristic of the spring arrangement F1 and F2 and knowledge of the measured path in the direction of measurement MR, it is possible to conclude the acting force F.

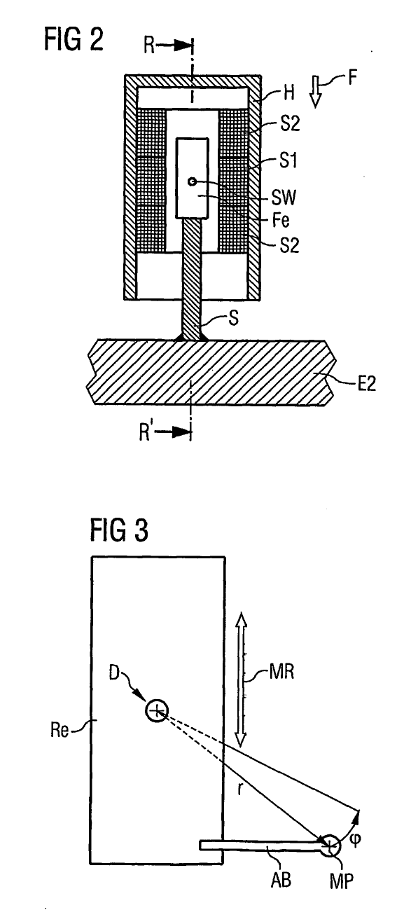

The position sensor S,H shown in cross-section in FIG. 2 along the section line R-R′ from FIG. 1 is preferably configured as an LVDT (Linear Variable Differential Transformer) sensor, with three coils S1 and S2 (double), which are interconnected magnetically by a ferrite core Fe. The coils S1 and S2 are inserted in a sleeve-shaped coil form H. The ferrite core FE is attached to a bar S and can be moved along the axis R-R′ toward the coil form H. The (primary) coil S1 is supplied with an alternating voltage, and as a result, generates a magnetic flux across the ferrite core Fe. Voltages are induced in this way in the (secondary) coils S2. The induced voltages are generally subtracted from each other. The differential voltage is a measure of the magnetic coupling between the primary coil and secondary coils, which is defined by the position of the ferrite core FE in relation to the coils S1 and S2. The resolution of such a position sensor can be in the gm range.

With the above embodiments, it has always been assumed that the coil form H is moved in a purely translatory manner in relation to the ferrite core Fe and bar St due to a linear force action F. FIG. 3, however, shows the problem of path measurement scanning underlying the invention in principle. If, for example, a rotary force acts about the fulcrum D on the body Re, which can in principle be moved in the direction of measurement MR, a measurement scanner AB with its measurement point end MP is also moved in a rotary manner about the angle of rotation φ. A deflection of r*cos(φ) in the direction of measurement MR is therefore determined on the basis of the distance r of the measurement point end MP from the fulcrum D and the angle of rotation φ, said deflection being based not on the action of a rectilinear force in the direction of measurement MR but solely on the presence of a torque. This torque simulates the presence of a translatory force.

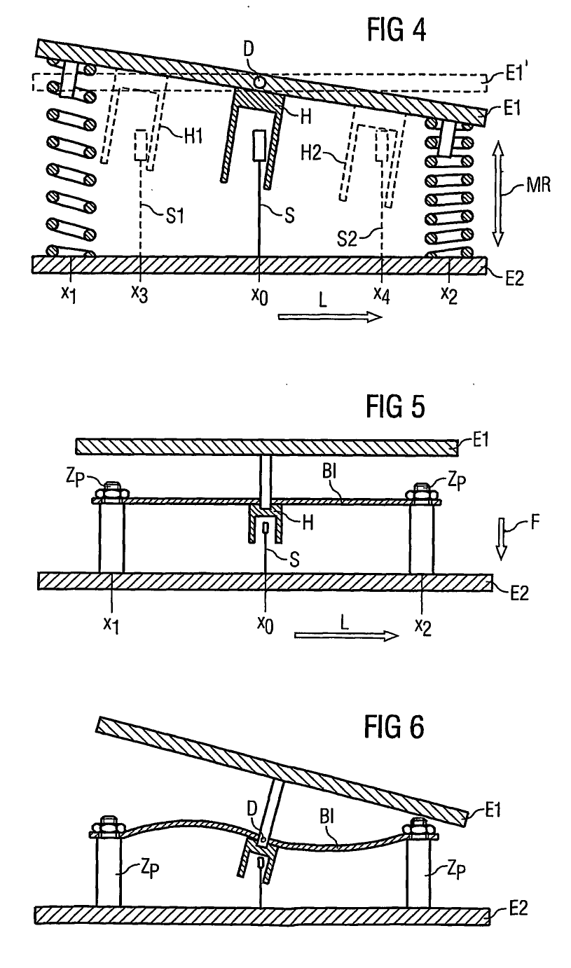

FIG. 4 now transfers this problem to a device according to FIG. 1. Here, a torque acts on the element E1, which as a result tilts about the fulcrum D. Clearly, the position sensor also tilts with its two units H and S toward each other. The position sensor H, S is however arranged according to the invention so that the sensor H, S does not detect any translatory components in the event of rotation about the fulcrum D. Simple tilting of the coil form H toward the bar S has no effect on the resulting differential signal of the LVDT sensor. Tilting, i.e. rotation about the fulcrum D, changes the magnetic flux in relation to the coils S1 and S2 in equal proportions. This immunity of the measurement to torque is due to the arrangement of the position sensor at position x₀ in relation to the longitudinal extension L of the second element E2. If the sensor H1, S1 were arranged in position x₃ in relation to the longitudinal extension of the second element E2, as shown with a broken line in FIG. 4, a clear rectilinear position change in the direction of measurement MR would be clearly identifiable at the sensor H1, S1 due to rotation of the element E1 about the fulcrum D. The same applies for an arrangement of the sensor H2, S2 at a position x₂ of the longitudinal extension L of the second element E2. In this position too, a clear path change in the direction of measurement MR would be clearly identifiable in the sensor H2, S2 due to rotation of the element E1, but this time in the opposite direction.

FIG. 4 shows that only an arrangement of the sensor H, S at that position along the longitudinal extension L of the second element E2 which is predefined by the projection of an anticipated fulcrum onto the longitudinal extension L of the second element E2—in FIGS. 1 and 4 position x₀—leaves the measurement result independent of acting rotation forces to the greatest possible extent. The fulcrum D for its part is in turn defined by the structure of the device and its geometry. In the case of the exemplary embodiment presented, the springs F1 and F2 are arranged at positions x₁ and x₂. The projected position of the fulcrum x₀ corresponds in its distance from the position x₁ to the distance (x₂−x₁)/2.

The sensor H, S is arranged in such a position, as can also be seen in FIG. 1. There the coil form H is connected securely via a screw connection with a nut M to the element E1. The sensor unit S, which supports the ferrite core covered by the coil form H in FIG. 1 for magnetic coupling purposes, is connected securely to the element E2, for example by welding.

The sensor will generally have a neutral position. This is, for example, defined by the fact that no force acts on the element E1 and its deflection is only defined by the force of the weight of the element E1 itself. In the case of the application of the device referred to below for identifying weight in vehicles, only the weight of the seat itself would act on the element E1. The sensor components H and S also adopt a specific neutral position in relation to this position of the elements E1 and E2 in respect of each other. For example, the ferrite core FE from FIG. 2 is then arranged symmetrically in relation to the coils S1 and S2, so that the same amount of voltage is induced in both coils S2. The sensor H, S according to FIG. 2 is shown in such a neutral position. The center point of the ferrite core is then referred to as the sensor center of gravity SW. Ideally, the fulcrum of the device or the fulcrum of the first element E1 now corresponds to the center of gravity of the sensor in its neutral position. Then a rotation of the coil form H about the fulcrum produces almost no signal contribution at the sensor output.

The device should preferably be designed so that the sensor is not only arranged on the perpendicular line of projection of the fulcrum onto the second element E2 but also so that the fulcrum corresponds to the center of gravity of the sensor in its neutral position, or at least only differs from this slightly. If the fulcrum is located inside a device, the sensor arrangement is constructed through a recess (e.g. hole) in this position. This also has the advantage of screening the sensor electrically and magnetically in the case of a device made of iron (EMC immunity).

FIG. 5 shows a further exemplary embodiment of the invention. Here spigots Zp, which support a leaf spring B1, project from an element E2. The leaf spring B1 is suitably clamped at the spigots Zp. The spigots Zp can also be configured as screws, etc. The leaf spring B1 is oriented parallel to the longitudinal extension of element E2 and can be deflected toward this when subject to the action of a force. An element E1 now also has a longitudinal extension and is connected securely to the leaf spring B1, with the connection engaging with the center of the leaf spring. A force F acting in a rectilinear manner on the element E1 now causes the deflection of the leaf spring B1 in the direction of the element E2 via this connection. This deflection also represents an influence on the acting force F and should be detected.

FIG. 6 now shows the arrangement from FIG. 5 subject to the action of a rotary force on element E1. This force is forwarded on to the leaf spring B1, which bends at the point of discharge of the force, thereby producing an S-shaped bending of the leaf spring B1. The point of discharge is at the same time the fulcrum of the system.

With the exemplary embodiment according to FIGS. 5 and 6, the position sensor H, S is also arranged on the projection of the fulcrum D onto the longitudinal extension of the element E2, at position x₀. The geometry of the device with the bearing points x₁ and x₂ for the leaf spring is such that a fulcrum D results during the action of a rotational force at position x₀, which in turn is at a distance (x₂−x₁)/2 from the point x₁.

The invention is extremely suitable for use in motor vehicles for determining the weight of vehicle occupants or objects on vehicle seats. These variables are necessary in order to be able to influence the inflation response of an airbag and in some cases even to prevent inflation, when, for example, the presence of a child seat is identified.

Here the element E1 is generally a vehicle seat runner, the element E2 the floor panel. The seat runners are each supported above two of the proposed devices in spring contact with the vehicle floor, with the devices each preferably being arranged at the end of a seat runner.

The advantages of the invention are particularly valid when it is deployed in this way. It is desirable for the occupant weight acting downwards in a rectilinear manner particularly to be determined alone without the influence of rotary forces on the seat, as act on the seat for example when the vehicle brakes.

1. A device for determining a weight of vehicle occupants or objects on vehicle seats, comprising:
first and second elements where a distance between the first and second elements depends on a force acting thereon, and the second element has a longitudinal extension;
a spring arrangement, which connects the first and second elements, the spring arrangement containing a leaf spring, with the leaf spring being oriented parallel to the second element, secured at its ends at spigots connected to the second element and coupled to the first element in such a way that a force from the first element is transferred to a position of the leaf spring that is central in relation to its longitudinal extension;
a position sensor for determining position of the first element in relation to the second element, wherein
the first element can be tilted about a fulcrum in relation to the second element, and the position sensor is arranged centrally between spigots.

2. The device according to claim 1, wherein the position sensor contains two interacting units where one of the two interacting units is connected to the first element and the other interacting unit is connected to the second elements.

3. The device according to claim 1 wherein the position sensor configured as an LVDT sensor.

4. The device according to claim 1, wherein the first element also has a longitudinal extension and the first and second elements are arranged parallel to each other and can be moved toward each other against a spring force of the spring arrangement.

5. The device according to claim 1, wherein one unit of the position sensor is arranged on the leaf spring and another unit of the position sensor is located on the second element.

6. The device according to claim 5, wherein the first element is configured as a vehicle seat runner and the second element is configured as a floor panel.

7. (Canceled)

8. (Canceled)
